(19) United States
(12) Patent Application Publication
(10) Pub. No.: US 2015/0012299 A1
(43) Pub. Date: Jan. 8, 2015

(54) Surgical Companion Computer Program Product, Method and System

(71) Applicant: Navjot Kohli, Milwaukee, WI (US)

(72) Inventor: Navjot Kohli, Milwaukee, WI (US)

(21) Appl. No.: 14/038,567

(22) Filed: Sep. 26, 2013

Related U.S. Application Data
(60) Provisional application No. 61/707,931, filed on Sep. 29, 2012.

(51) Int. Cl. G06F 19/00; H04W 8/18; H04W 4/14; H04W 4/12

(52) U.S. Cl. CPC G06F 19/322; H04W 4/12; H04W 8/18; G06F 19/327; H04W 4/14
USPC 705/3

(57) ABSTRACT

The Surgical Companion™ system, method, and computer software are directed to a secure web based service provided to physicians to enable them to keep their patients and their patient's designated contacts (e.g. friends and family) informed of a patient's status during a surgical procedure, and to provide pre-operative and post-operative instructions regarding patient care. Physicians create an account on a system server, wherein they accept or customize server template messages related to diagnosis or procedure. Diagnosis messages are sent automatically on physician designated dates via email and/or text to patients and their caregivers regarding patient pre-op and post-op care. Procedure messages are sent via peer-to-peer messaging between electronic devices in the operating room and the waiting room; and via web based text and email to friends and family remotely located from the hospital. The physician may also conduct real-time video conferencing regarding the patient's status via the electronic devices.

### CROSS-REFERENCE TO RELATED APPLICATION

This application claims the benefit of U.S. Provisional Application No. 61/707,931 filed Sep. 29, 2012, incorporated by reference herein.

### FIELD OF THE INVENTION

The present invention relates to a system, method, and a computer program for transmitting electronic messages to a patient and their designated contacts before, during, and after a surgical procedure.

### BACKGROUND OF THE INVENTION

When a patient undergoes a medical treatment, such as one requiring invasive surgery, there may be important information that the physician needs to provide to the patient and their caregivers (family and friends) regarding the patient care. Historically, this information has been provided in a written document routinely handed out to patients as they are leaving the doctor's office. It is not uncommon for this document to subsequently be misplaced, accidently thrown out, etc. such that the patient and/or their caregivers never have the opportunity to read the document and thus comply with the instructions (e.g. follow-up appointments, restricted diets, hospital check-in time and procedure, etc.).

Additionally, when a patient is undergoing a surgical procedure, the family and friends are anxiously awaiting word from the operating room as to the patient's status, and why, for example, the surgery is taking so long. And once the patient's family and friends within the hospital waiting room are informed of a patient's status, they may need to call other family and friends outside of the hospital to relay the information (e.g. in the same city, or at a remote location—different state or country).

Therefore, there needs to be a system within today's era of instantaneous electronic communication of relaying patient care instructions, appointments, as well as their surgical status in real-time via the Internet without compromising patient confidentiality.

### SUMMARY OF THE INVENTION

The Surgical Companion™ system, method, and computer software are directed to a secure electronic communication web based service provided to physicians to enable them to keep their patients and their patient's designated contacts (e.g. friends and family) informed of a patient's status during a surgical procedure, and to provide pre-operative and post-operative instructions regarding patient care.

The service comprises a system server, the Surgical Companion™ software housed on the server, and a database storing physicians' records accessible via a secure network (e.g. encrypted Internet transmissions). Through their system account accessible over the Internet at a system website, the physician is able to create and update a record for each patient undergoing a surgical procedure by the physician, and save a computer record of all electronic communications with the patient and/or their contacts.

The electronic communications comprise subject matter pertaining to the “diagnosis”, which are pre-operation and post-operation messages, such as instructions for patient care before and after the surgery, directions to the surgical ward of a hospital and check-in procedures, etc. These messages will be sent via encrypted SMS text and/or email to the patients and their designated contacts.

The electronic communications further comprise subject matter pertaining to the surgical “procedure” that the patient is undergoing. The communications primarily comprise status updates on the patient before, during, and immediately after the surgery that are electronically transmitted to the patient's contacts within the hospital via a secure hospital network, and/or to patient's contacts outside of the hospital via email and SMS text.

Via the system website, the physician elects whether to use and/or modify template diagnosis and procedure messages, or to create his own. He also sets the date of automatic delivery of the diagnosis messages by the system server. While these decisions can be made and/or changed at any time, they are applicable to all patients with a certain diagnosis and/or procedure (e.g. after the physician selects the rotator cuff repair procedure template, he simply enters in the patient's name, email, and phone number and their contacts email and text number, and the patient and their contacts will automatically receive all diagnosis electronic messages on the preset date).

The physician also utilizes his web-based account to create or modify existing template “procedure” messages used on the day of surgery to keep the patient's family and friends informed to the patient's status within the operating room. The server template messages are specific to a type of surgery. Once the physician creates and/or updates his procedure messages on the system server, they are uploaded to the computer file of each of his patient's undergoing that particular type of surgery. A patient's procedure messages are then downloaded before the surgery to a first electronic computing device used by the physician or his staff to communicate during the surgery with the patient's contacts via a second electronic computing device. Both devices may further comprise Surgical Companion modules (e.g. mobile applications) to enable functions of the present invention (e.g. downloading the patient's messages from the system server and syncing two electronic devices to communicate via peer-to-peer messaging using the hospital's wireless network).

On the day of surgery, the staff assigns the second computing device to the contacts after logging into the patient's file. Each patient has a unique computer generated password that must be entered into an activation screen before the computing device can receive messages sent from the physician. Messages are then electronically transmitted one-way via the hospital wireless Internet system by the physician or his assistant from the device within the operating room (e.g. iPod®) to the contact's device in the waiting room (e.g. iPad®). And for FaceTime® enabled devices, the physician may also conduct real-time video conferencing regarding the patient's status with their contacts in the waiting room.

All messages sent through the system server and/or directly peer-to-peer are encrypted to be in compliance with HIPPA and HiTech regulations, and all electronic computing devices are HIPPA and FDA approved. No patient identifying information is electronically transmitted to the patient's contacts.

It is also noted that the history of transmission of the “procedures” messages stored in the system server may be utilized to improve a surgical team's performance. By analyzing the time that each status report is sent for a dataset of patient's undergoing the same procedure; a computer processor can determine where there are delays during the surgery and adjust the operating room routine accordingly.

### BRIEF DESCRIPTION OF THE DRAWINGS

The above and other features, aspects, and advantages of the present invention will become better understood with regard to the following description, appended claims, and accompanying drawings where:

FIGS. 1A-1C are illustrations of screen shots of the Surgical Companion software of the invention as utilized on an iPod® and iPad® electronic devices.

FIGS. 2A and 2B are flowcharts for steps taken by the physician and/or his staff for practicing the present invention. FIG. 2A comprises steps taken on the day of surgery. FIG. 2B comprises steps taken before and after the say of surgery.

FIG. 3 is a schematic diagram of the system architecture comprising the physician communication with the system server via a system website, and electronic communications between a computing device within the operating room to a computing device in the waiting

FIGS. 4A and 4B are illustrations of screen shots for a physician to create his account on system server.

FIGS. 5A and 5B are illustrations of screen shots for a physician to create, modify, or accept existing template messages for patient “diagnosis” and to set the date of their transmission to the patient and their contacts.

FIGS. 6A and 6B are illustrations of screen shots for a physician to create, modify, or accept existing template messages for a specific type of surgical “procedure” that are transmitted to the patient's contacts during a surgery.

FIGS. 7A-7C are illustrations of screen shots for a physician to update his profile on the system server, and to add additional staff members to his account.

FIGS. 8A and 8B are illustrations of screen shots for inputting patient information into the system database comprising patient diagnosis, procedure, and their family and friends contact information, and the type of messages to send them.

FIGS. 9A-9C are illustrations of screen shots for diagnosis messages that are edited and shared by the system administrator.

FIGS. 9D-9F are illustrations of screen shots for procedure messages that are edited and shared by the system administrator.

FIG. 10 is an illustration of a screen shot for archiving a patient's record and the messages electronically sent to the patient and their contacts.

### DETAILED DESCRIPTION

Glossary of terms

As used herein, the term “User” refers to the health care professional (e.g. medical doctor or assistant) who utilizes the computer program product of the present invention to create patient files, select and/or customize the messages electronically transmitted to the patient and/or their designated contacts.

As used herein, the term “Electronic Computing Device” refers to any electronic device comprising a central processing unit (i.e. processor) with the ability to transmit and receive electronic communications via Internet and/or cellular connectivity, such as: laptops, desktops, tablets, iPads®, iPod Touch® and smartphones, cell phones, and personal digital assistant devices. In particular, the electronic computing devices have the ability to run the Surgical Companion™ modules or software of the present invention to control the electronic transmission of messages regarding patient care before, during, and after a surgical procedure.

As used herein, the term “A System” may be used to claim all aspects of the present invention wherein it refers to the entire configuration of hardware and software in all embodiments. In a preferred embodiment, the “system” comprises a user computing device with Internet connectivity (e.g. laptops, tablets, smartphones, etc.) and/or cellular connectivity. In an alternative embodiment of the present invention, the system comprises a client-server architecture comprising a user computing device with Internet connectivity, such as laptops, tablets, and smartphones, to communicate with a system server via a network, wherein the software of the present invention is installed on the system server and electronically communicates with the user's device over the Internet. Furthermore, the user's computing device may have modules of the present invention installed to assist in inserting comments into videos.

As used herein the term “Client” computer or computing device refers to any electronic computing device capable of communicating with a remote server via the Internet and/or cellular means such as a iPad®, iPod Touch®, smartphone, hand-held “palm top” computer, laptop computer, desktop computer, terminal, PDA (Personal Digital Assistant), PIM (Personal Information Manager), Network computer, wireless communicator (such as a cellular or satellite telephone), or a multi-User computing system. In a preferred embodiment, the “client” computer comprises an iPad® provided to the patient's contact during the surgical procedure, the electronic computing devices of the patient and their designated contacts (e.g. smartphones, laptops, etc.) providing information about the diagnosis (e.g. pre and post-surgical instructions) transmitted via email and/or SMS messages; and iPod Touch® of the clinician used during the surgery to transmit procedural messages to the patient's contact within the hospital and via text messaging outside of hospital.

As used herein the term “Server” computer refers to any computing device that stores runs a Surgical Companion™ computer program of the present invention, houses the system database comprising patient and doctor files, and communicates periodically with the Surgical Companion™ modules stored on the patient's and their contacts electronic computing device (e.g. iPad™, iPod Touch™, smartphones, etc.). The server system also facilitates the collection distribution of content to and from a multiplicity of client computers.

As used herein, the term “Software” refers to computer program instructions adapted for execution by a hardware element, such as a processor, wherein the instruction comprise commands that when executed cause the processor to perform a corresponding set of commands. The software may be written or coded using a programming language, and stored using any type of non-transitory computer-readable media or machine-readable media well known in the art. Examples of software in the present invention comprise any software components, programs, applications, computer programs, application programs, system programs, machine programs, and operating system software.

As used herein, the term “Module” refers to a portion of a computer program or software or algorithm that carries out a specific function and may be used alone or combined with other modules of the same program.

Exemplification

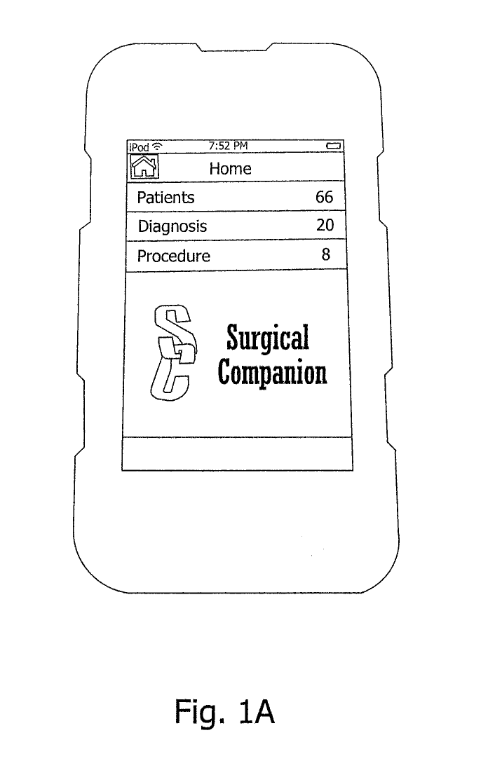

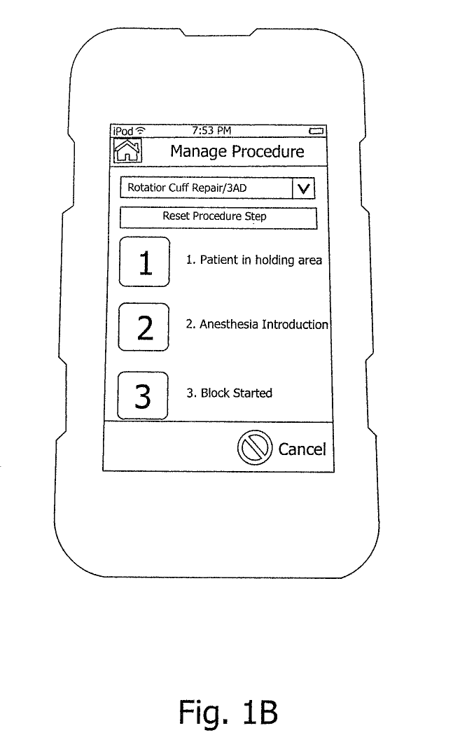

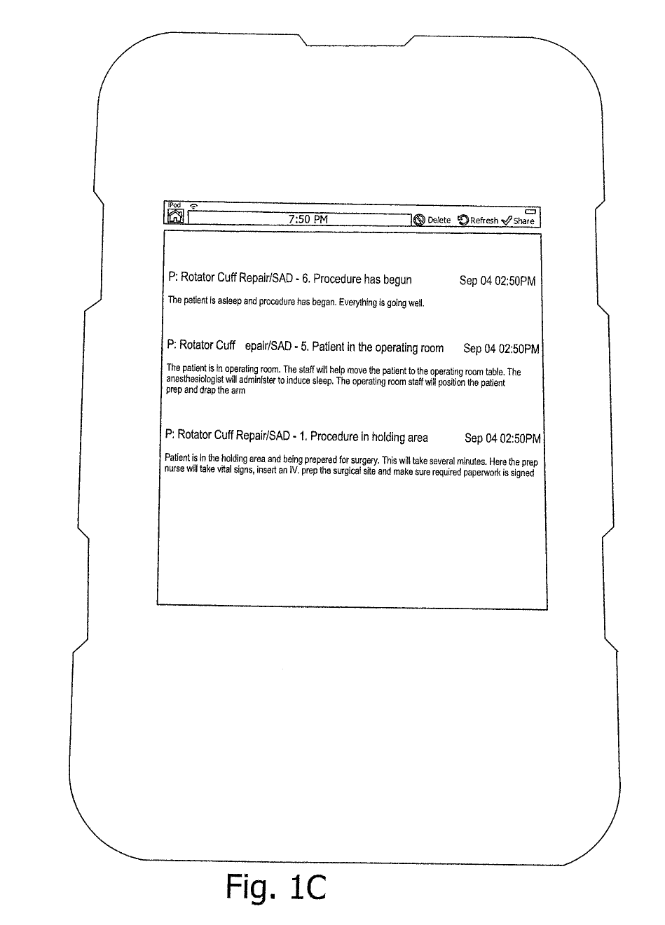

FIGS. 1A-1C provide an exemplification of a preferred embodiment of the invention comprising an iPod Touch® for use by a physician or his operating room staff, wherein the device is synced with a tablet (e.g. iPad®) for use by the patient's contacts in the hospital waiting room. As illustrated in FIG. 1A, on the day of surgery the physician or his staff logs into their account on the system server (or the application stored on the device's memory), and selects the “Patient” option from the three options of “Patient”, “Diagnosis” and “Procedure”. The physician will then select the patient record, and the pre-set messages of FIG. 1B will be displayed. Then during the operating procedure the physician will select the messages at the appropriate time, and they will immediately be electronically transmitted to the patient's contacts in the waiting room, as illustrated in the iPad screen of FIG. 1C. They will also be electronically transmitted to the patient's contacts outside of the hospital via email and web based SMS text messaging.

The messages comprise patient status updates, such as “The operation has begun”, “Patient has been transferred to the holding area, and the physician will be out shortly to see you.” The messages can be standard template messages for a particular type of surgery provided by the system, or they can be customized by the physician. In either case the messages are for a particular type of surgery, versus a particular patient. In a preferred embodiment, a total of 10 messages are allowed, although other numbers are envisioned within the scope of this invention

Day of Operation

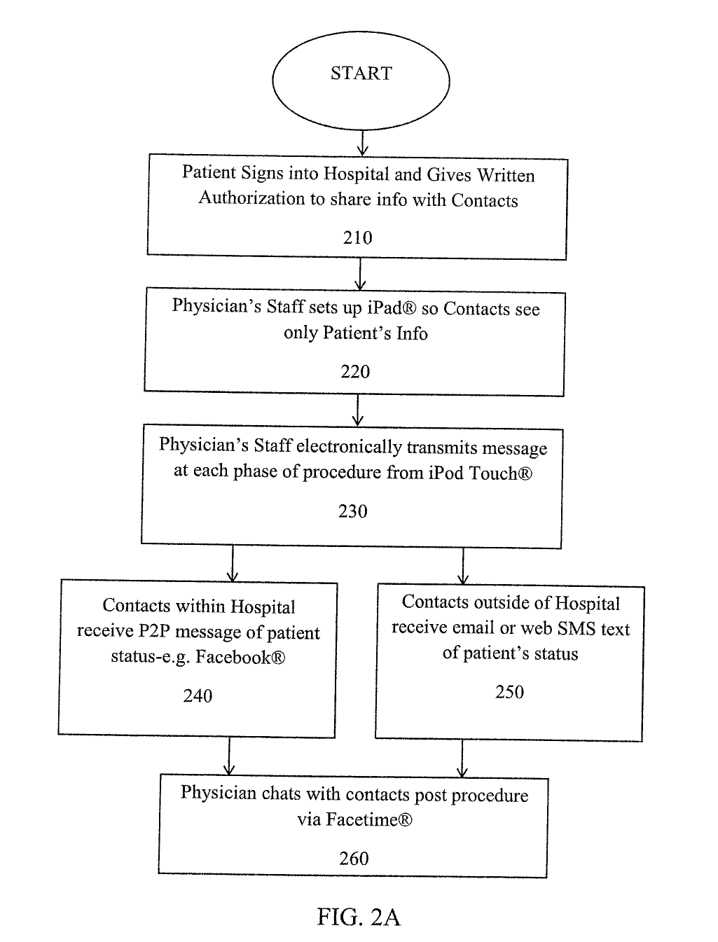

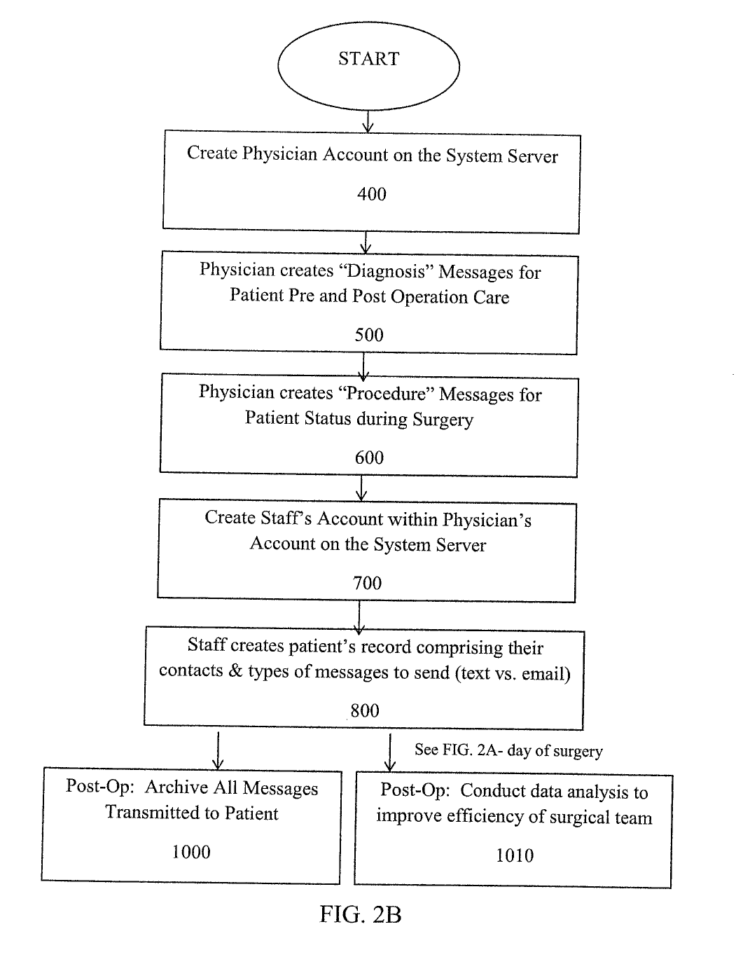

The flowchart of FIG. 2A outlines the steps that occur for keeping a patient's contacts informed of the patient's status before, during, and after a surgical procedure. On the day of the scheduled surgery, the patient checks into the hospital, whether it is for a same-day procedure or one requiring at least one overnight admittance. If the patient has not already provided written authorization for their friends and family (i.e. contacts) to receive electronic messages from the physician during the procedure, they may do so during check-in (FIG. 2A, 210).

The physician's staff will then provide the patient's contacts an electronic device for receiving messages from the operating room during the surgery. In a preferred embodiment, the device is an iPad® with peer-to-peer messaging capabilities. The staff will also enter patient specific login credentials generated by the system server. As a result, the patient's contacts will only be allowed to view messages regarding their patient, and no other patient within the system server (FIG. 2A, 220). The contacts may then use the device to access the Internet via the hospital's wireless network.

Before, during and after the surgery the staff and/or the physician will utilize a second device enabled for peer-to-peer messaging and Internet email and Internet SMS text messaging to the contacts. In a preferred embodiment, the second device that is in the operating room is an iPod Touch®. The messages will comprise what the staff is doing at that phase of the procedure (e.g. administering anesthesia), and the date and time of the message. Because the messages are created and saved prior to the surgery, they will not contain any emergency or unanticipated patient status events (FIG. 2A, 230).

For contacts within the hospital, the messages will be transmitted over the hospital secure Internet system. The contact's device may be setup (based on the computer modules installed on the device) to receive the messages via peer-to-peer messaging. If the contact is logged into another site, such as Facebook®, the instant message may appear within their chat messages (e.g. via Facebook's iChat application) (FIG. 2A, 240).

Contacts outside of the hospital, including those located in other geographic locations—states and countries—may receive emails, instant messages VoIP (e.g. Skype®), and/or Internet based SMS text messaging regarding the patient's status (FIG. 2A, 250). The contact's emails, text number, or VoIP username must have been previously inputted into the patient's record on the system server database for this to occur.

The physician may also video chat from the surgical ward with the contacts that are using the iPad within the waiting room via FaceTime® applications. (FIG. 2A, 260).

The physician's device (e.g. iPod Touch®) will automatically download to the system database a copy of all messages sent to the patient's contact and the timestamp of the messages. And the physician can update the patient's record stored on the system database from the computing devices.

### Pre-Operation System Account Setup and Management

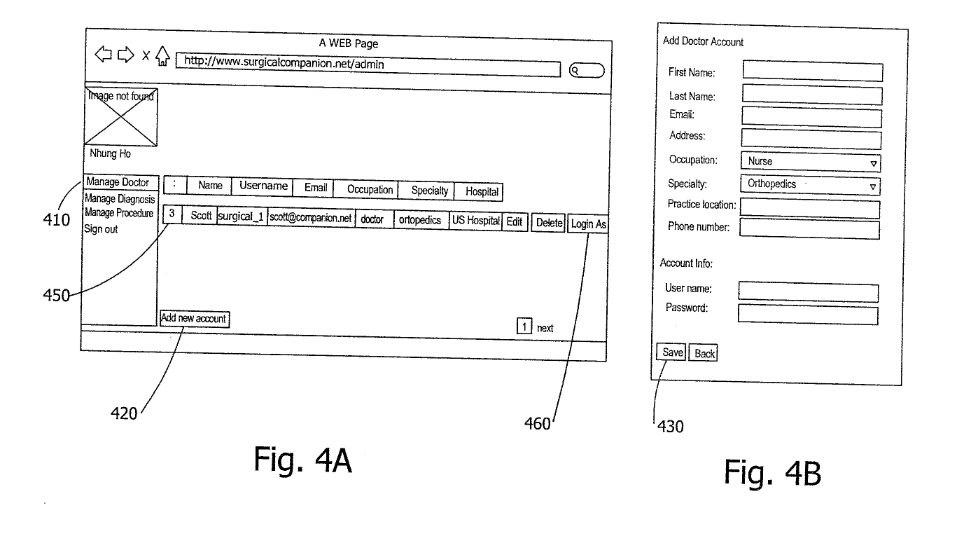

The flowchart of FIG. 2B discloses the general process steps taken by the physician and his staff when utilizing the Surgical Companion software and service of the present invention. A more detailed account in each step is disclosed infra as pertains to FIGS. 4-10.

The physician creates an account on the Surgical Companion™ (SC) system server via the SC's website (FIG. 2B, 400). All of his records will subsequently be stored on the system server by patient, and by the type of surgery performed.

For each type of surgery the physician performs, he will use template provided messages from the system, and/or modify the templates and/or create his own “diagnosis” messages. The messages comprise a time sequential series of instruction (wherein the physician will direct the patient and their caregivers regarding pre and post-operation patient care. Instructions can be wide ranging in topic—from prescription dosage schedules, to follow-up appointment schedules, to restricted diets, emergency situations, etc. (FIG. 2B, 500). The messages are saved on the system server under the physician's record on the database.

The physician also utilizes system provided template “procedure” or surgery messages, and/or he can modify the messages, and/or create his own. The procedure messages comprise a time sequential series of notifications of the patient's status pre-op, during, and post-op for a specific type of medical procedure (FIG. 2B, 600).

The physician's staff members may then be added to the physician's account. For example, the physician may require that his nurse or physician assistant have the authority to access the physician's files on the system (i.e. Surgical Companion™) database to create and/or modify patient's records (FIG. 2B, 700). The staff will all enter the patient's contact information, and their friend's and family's contact information amongst other data (FIG. 2B, 800). During the surgery, the staff will electronically transmit the messages to the contacts at the appropriate time (see FIG. 2A).

### Post-Operation Message Processing and Analysis

After the surgery the staff will store all messages transmitted to the patient and their contacts within an archived filed on the system server, wherein the date and time of transmission is recorded (FIG. 2B, 1000). Alternatively, the system server will automatically “archive” the history of the messages in a manner that is complaint with patient privacy and medical record storage regulations.

The system processor (CPU) subsequently analyzes the time the messages are sent from the operating room to the contacts for each phase of the procedure to determine the operating room efficiency (FIG. 2B, 1010). For example, the processor determines the time it takes for the nurse to push the button “patient is in the holding area” to when she pushes “procedure has begun.” The system will then compare this time amongst physicians, facilities, and types of procedures so as to determine which are the most efficient. The system will then generate reports comprising the results of the analysis, and electronically transmit the reports to the appropriate parties (e.g. hospital administrators).

### System Architecture

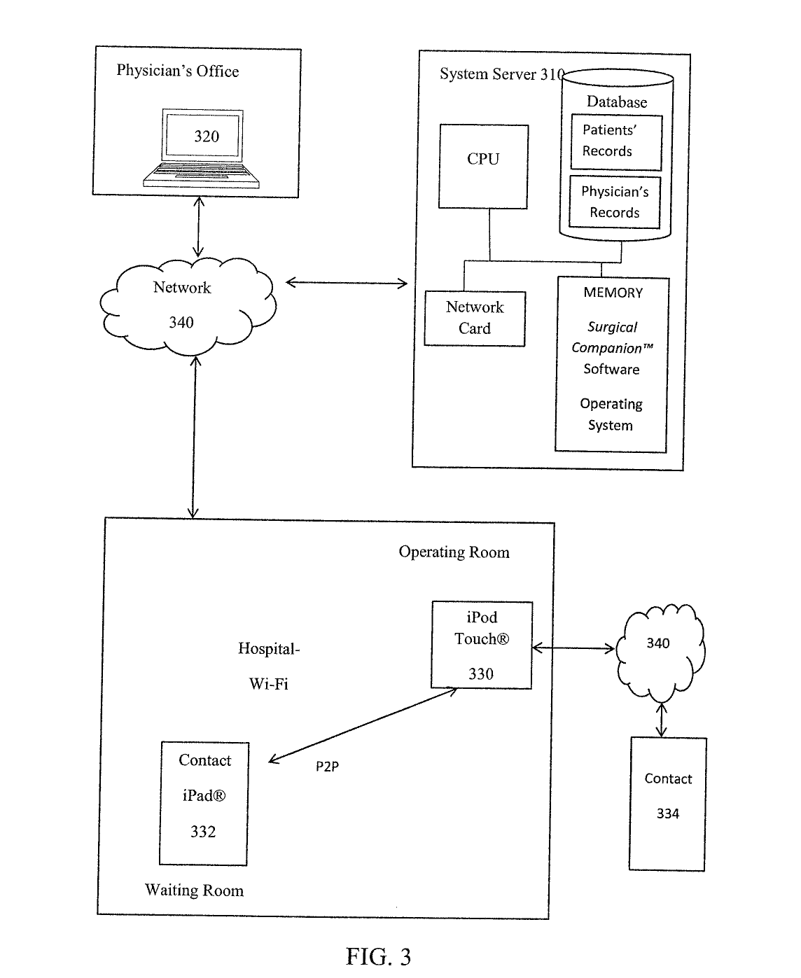

One embodiment for the system architecture is illustrated in FIG. 3, and comprises a client-server layout 300 wherein the computer program product (e.g. “Surgical Companions™”) is installed on a system server 310 and accessible from a client computer (e.g. electronic computing device with Internet and/or cellular connectivity—iPad®, iPod Touch®, smartphone, laptop, and cell phone) via the network 340.

The Client System 320, 330, 332, 334: The system may comprise multiple users (doctors, nurses, patients, patient's contacts, etc.), each with a client computer capable of communicating with the server system 310. Some client computers connect directly with the system server 310 via the network 340 (e.g. Internet), such as a doctor's laptop 320 from which he creates and manages patients' records and electronic messages from a Surgical Companion™ website. Communication means between the physician and the patient and their contacts may include e-mail, SMS text, MMS, pre-recorded and/or real-time video or audio content, photographs and/or web-enabled messaging (e.g. VOIP—Skype®).

Client computers used within the hospital may connect via the hospital wireless network, such as directly in peer-to-peer communications with a secure software platform. Client computers comprise the doctor's electronic computing device within the operating room 330 (e.g. iPod Touch®) used to transmits electronic messages to the patient's contacts in the waiting room. These contact's client computers 332 may comprise for example tablets (e.g. iPads®). Both of the client computers have Surgical Companions™ modules (mobile applications) installed on the electronic computing devices, and may have other mobile applications to enable electronic communication for the present invention. For example, the devices may comprise modules to enable them for peer-to-peer (P2P) communications via the secure hospital wireless encrypted network depending on the medical facility and the specific client computing devices.

Devices used within the hospital operating room and in the waiting room may also be FaceTime® and/or Voice-over-Internet-Protocol (e.g. Skype) enabled, so that the physician may transmit real-time video conferencing regarding the patient's status to the patient's contacts in the waiting room. FaceTime® works by connecting an iPhone 4 or newer iPhone, a fourth generation iPod Touch® or newer iPod Touch®, a second generation iPad® or newer iPad®, or a computer with Mac OS X to another similar device. And for contacts within the hospital who are logged into third party social networking sites (e.g. Facebook®), the “procedure” messages can be sent directly to their Facebook® account if they have provided their Facebook® login, via third party applications such as iChat® and iMessenger®, or modules incorporated into the Surgical Companion application.

And some client computers 334 comprise an electronic computing device with Internet connectivity for communicating with the client computing device in the operating room 330, wherein the patient and/or their contacts receive automated emails and/or SMS text messaging via Internet from the doctor. For example, the contacts located outside of the hospital will receive an automated email and/or text during surgery with real-time updates of the patient's status. In an alternative embodiment of the present invention, devices 330 and 334 may also comprise cellular connectivity for text messaging.

Lastly, the client system may also comprise electronic computing devices with strictly cellular connectivity for receiving text messages from the system server comprising “diagnosis” messages sent from the physician's office days before, the day of, or days after the surgery.

The Server System 310: The system server computer consists of one or multiple high speed CPU's (Central Processing Unit(s), primary memory (i.e. RAM) and secondary storage device(s) (i.e. hard disk drives). The Surgical Companion™ software, the operating system and the database comprising physicians' and patients' records are housed within the system server. The server system is coupled to the remote network (such as the Internet), and can communicate and exchange information with a multiplicity of client computing devices (320, 330, 332, & 334) simultaneously.

### Surgical Companion Server Software and Mobile Device Modules

The present invention comprises the Surgical Companion™ computer program product which comprises the software housed on the system server 310 and/or the modules installed on the client electronic computing devices. The client computing devices (e.g. smartphone, iPad®, iPod Touch®, laptop, etc.) may comprise a Surgical Companion module comprising a native application, a web application, or a widget type application to carry out the methods of graphically displaying messages comprising a patient's diagnosis and instructions for patient care, and/or status during a surgical procedure. In a preferred embodiment, a native application is installed on the device, wherein it is either pre-installed on the device or it is downloaded from the Internet via email and activated with a code generated by the system server. It may be written in a language to run on a variety of different types of devices; or it may be written in a device-specific computer programming language for a specific type of device. In another embodiment, a web application resides on the system server 310 and is accessed via the network 340. It performs basically all the same task as a native application, usually by downloading part of the application to the device for local processing each time it is used. The web application software is written as Web pages in HTML and CSS or other language serving the same purpose, with the interactive parts in Javascript or other language serving the same purpose. Or the application can comprise a widget as a packaged/downloadable/installable web application; making it more like a traditional application than a web application; but like a web application uses HTML/CSS/JavaScript and access to the Internet.

The computer program also comprises code (module) for permitting text messaging via a wireless connection. The program can be linked with an existing mobile application that enables texting after assigning a phone number to the device, or by using an existing user's email address. Mobile applications for texting from via the Internet device are widely known in the art, and comprise for example: TextFree Unlimited, TextNow, Brightkite Group Text, Textie Messaging, and TigerText. Or the program may incorporate its own software modules stored on the devices that enables texting from the device within the operating room to contact's within and outside of the hospital. Physician Enrollment

As illustrated in FIGS. 4A and 4B, a doctor (or system server administrator) using the Surgical Companion™ system for the first time must create an account on the system server. This requires selecting the “Manage Doctor” tab (FIG. 4A, 410), then the “Add New Account” tab 420, which directs the user to a new screen to input the doctor's data (FIG. 4B). Once the “Add Doctor Account” information is inputted and saved (FIG. 4B, 430), it generates a row within the table (FIG. 4A, 450). The new account information is also sent to the physician's email as a copy for his own records, and to notify him in the event another party created the account under his name. The physician then hits the “Back” button of FIG. 4B to be re-directed back to the screen of FIG. 4A.

Records for all of the doctors with accounts stored on the system server may be viewed by selecting the “Login As” tab (FIG. 4A, 460), such as by the system server administrator and any other user of the system. The information disclosed for each doctor comprises their patients who have agreed to participate in the Surgical Companion™ notification system, demographic information about the patients, messages the doctor has sent the patient and their designated contacts, etc.

### Physician Creates Diagnosis Messages

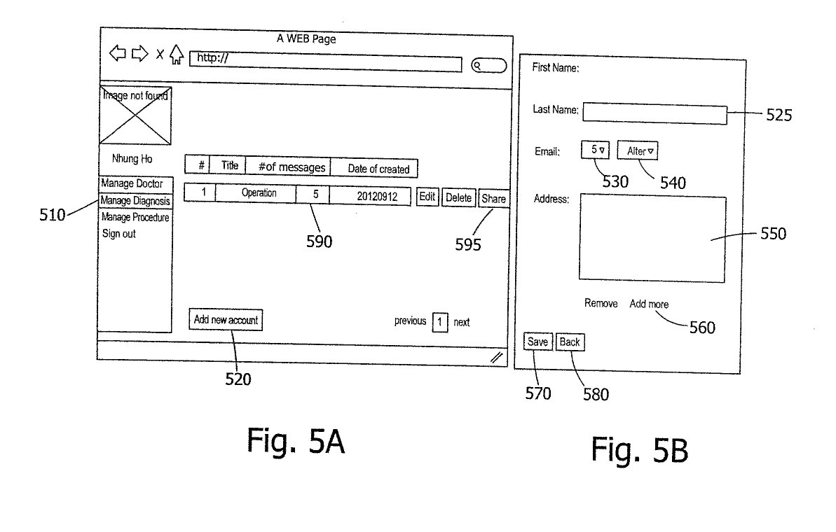

As illustrated in FIGS. 5A and 5B, the physician modifies existing messages and/or creates new messages to be sent to the patients and/or their contacts before, during and after the surgery comprising instructions regarding the care of the patient, appointments, etc. The system server will provide template messages (created usually by a super administrator) according to the particular type of medical procedure being performed. The physician may choose to modify the existing template message or create his own message, wherein he would select the “Manage Diagnosis” tab (FIG. 5A, 510), the “Add new diagnosis” 520 which displays the template messages for the particular type of operation, and then enter data into the screen 550 in FIG. 5B that modifies or completely rewrites an existing template message.

The “Title” item 525 in FIG. 5B refers to the type of operation, and the “Date” item refers to the number of days 530 before or after 540 a surgery, with a corresponding message of instructions for patient care 550. The physician then saves the message 570, and if he wishes to add another message for a different date, then he selects the “Add more” tab 560.

Once the physician has completed inputting all of the messages related to the pre-operative and post-operative care of a patient for a particular type of surgery, he selects the “Save” tab (FIG. 5B, 570), and the “Back” tab 580 that will be redirect him back to the screen of FIG. 5A. The messages that he created will be stored in one file accessible by clicking on the name of the operation or number of the item within row of a table comprising the different types of operations performed by the physician. The table will also show the number of messages created for that particular type of surgery as exemplified in FIG. 5A, 590 with “5” representing five messages that will be sent.

The “Share” button 595 of FIG. 5A, enables the system administrator to forward the diagnosis messages stored in a particular operation file with other system users. Therefore, the system administrator can create templates for a particular type of operation from this webpage, and elect to share them with: 1) a specific doctor; 2) all doctors; or 3) all doctors and staff members within a specific medical specialty (e.g. orthopedics). Each message will automatically be transmitted via email and/or SMS text messaging.

### Physician Creates Procedure Messages

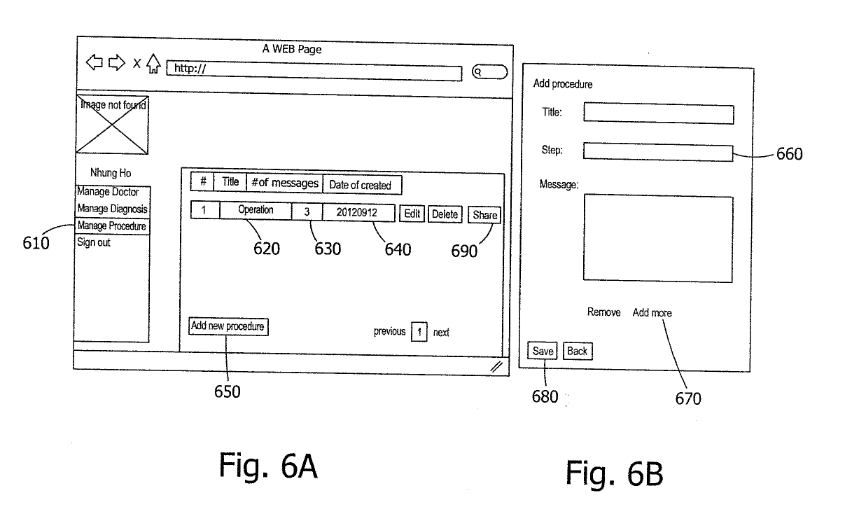

As illustrated in FIGS. 6A and 6B, the physician views the system server's template messages and/or creates customized messages for each type of surgical procedure by clicking on the “Manage Procedures” tab 610. A list of the types of operations 620 that he performs is displayed, as well as the total number of messages 630 that will be transmitted to all of a patient's contacts during the operation, and the last date that the file was updated 640 on the system server for that particular operation.

The physician can elect to edit or delete a particular operation file, or create a new one, by selecting the “Add new procedure” tab 650, which redirects the physician to the screen of FIG. 6B. The physician will see template messages provided by the system in FIG. 6B, which he can modify. He can also add his own messages by selecting “Add more” 670 and then saving 680 the entire operation file after all the steps have been entered into the system database (with one message per step of the operation 660). In a preferred embodiment, about 10 messages are permitted in the Surgical Companion™ software for each type of operation.

The physician or system administrator also has the option of sharing a particular type of operation file and all of the messages associated with it by selecting the “Share” button of FIG. 6A, 690. Selecting this option forwards the file to: 1) a specific doctor; 2) all doctors; or 3) all doctors and staff members within a specific medical specialty (e.g. orthopedics). Each message will automatically be transmitted via email and/or SMS text messaging.

### Create Staff Account on System Server

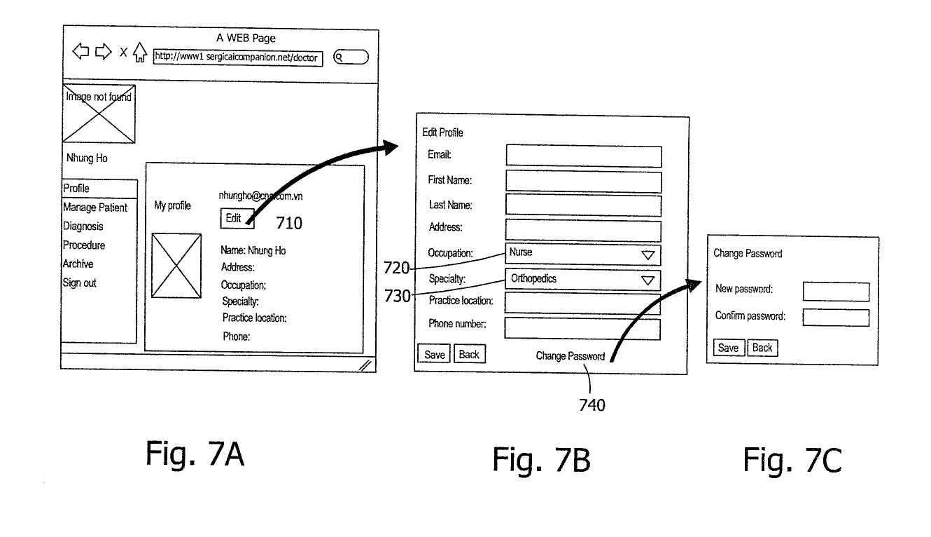

Once a physician's account is created on the system server, additional staff members may be added to his account, and/or he may modify his own profile, by going to the profile page as illustrated in FIG. 7A.

By selecting the “Edit” button 710 in FIG. 7A, the user will be redirected to the screen of FIG. 7B, wherein the user will input the appropriate data. They may also use drop-down menus to select their occupation 720, and their medical specialty 730. On this screen, they can also elect to change their password 740.

All system server users have access to all patients' files, therefore the system administrator (e.g. Super Administrator) will approve whether or not an individual who registers on the system will have access to the system database. The system server will also keep a record of all logins to the system and the files accessed to determine is a specific user is inappropriately accessing files, wherein their system account will be terminated.

### Manage Patient

The patient provides written authorization to the physician's office or hospital to permit electronic transmission of messages to family and friend's (e.g. designated contacts). This authorization can be in person, via routine electronic messages (e.g. email), and/or the patient may be electronically sent an activation code with a link that permits them access to a restricted part of the system server database to permit them to input this information themselves. The messages sent to the contacts comprise instructions for pre-op and post-op patient management “diagnosis messages” and/or the patient's status during the surgery “procedure messages”.

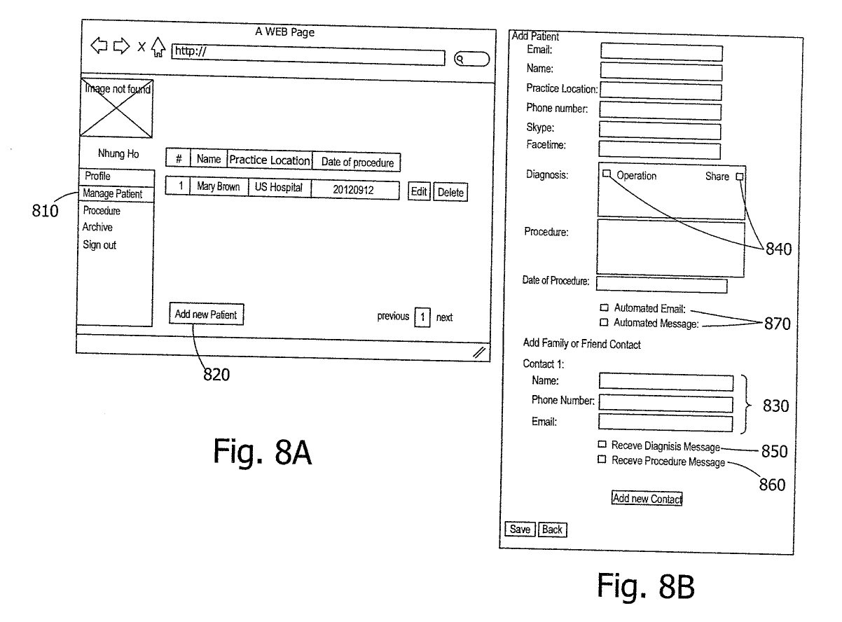

As illustrated in FIG. 8A, the physician's staff will create a file for each patient by selecting “Manage Patient” 810, and “Add new Patient” 820. The staff will then manually input the patient information into the screen of FIG. 8B, or the system will in-port it from another file or system comprising medical records. For example, when the patient provides the written authorization to share their status with their family and friends, they also provide their contacts' name, phone number, and email address (FIG. 8B, 830). And they indicate whether the physician should send their contacts messages regarding their diagnosis 850 and/or their status during the procedure 860.

In the preferred embodiment as illustrated in FIG. 8B, each contact is added one-by-one and stored in a separate “contacts list” file (not shown). The staff also inputs the patient's contact information (e.g. email, Skype®, Facetime®), date of procedure, diagnosis, and procedure. When the staff inputs the diagnosis, they will see the type of operation the patient is scheduled for (see “Operation” 840), and whether the messages can be sent to a social media address (e.g. Facebook®, Twitter®, etc.) (See “Share” 840). They also select if the patient has indicated that they wish to receive the messages via email, and/or SMS text message 870.

Selecting items 850, 860, and/or 870 of FIG. 8B enables the system server to transmit all the “Diagnosis” messages (FIG. 5A) and all the “Procedure” messages (FIG. 6A) stored in a physician's file for the particular type of operation that the patient is undergoing to the patient (870) and/or their contact's (850, 860).

### Physician Modified Super Administrator's Template

The primary author of the templates utilized by the physician is the super administrator of the system server. A “Super Administrator” or “Super User” may comprise the manager of the system server, such as the entity maintaining the system server for which the physician pays a fee or a designated individual responsible for all physicians within a medical group or setting.

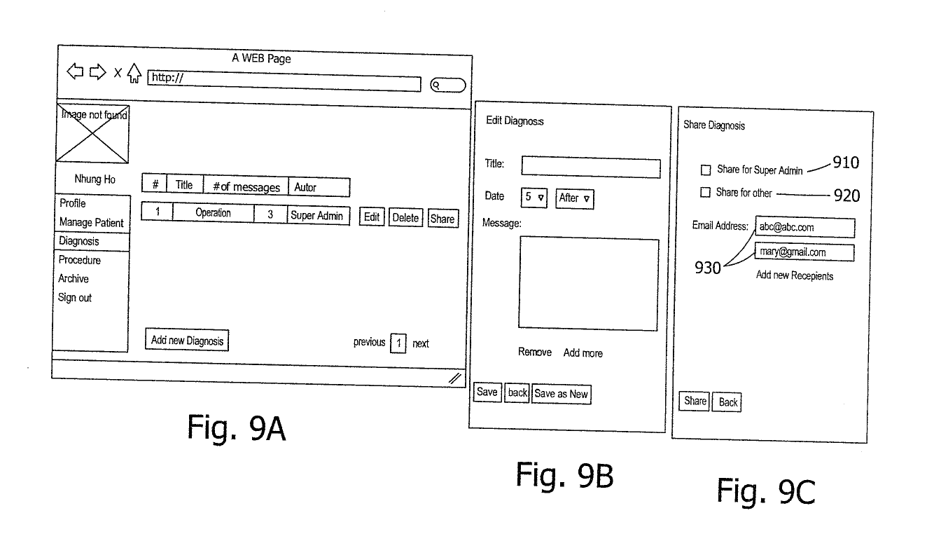

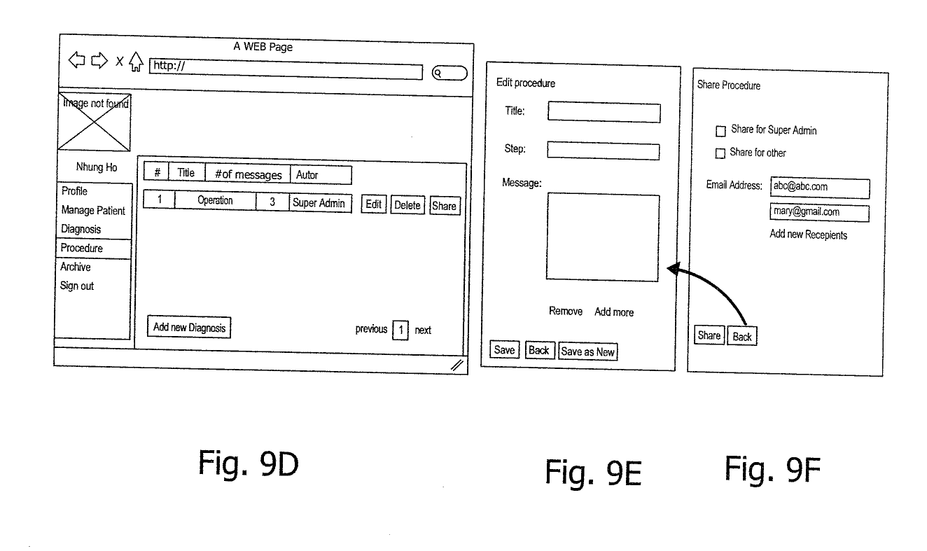

While a super administrator creates most of the templates for each type of surgical procedure, a physician system user may modify one of these templates, and then share it with the super administrator and/or other physician's within the system server. For example, and as illustrated in FIGS. 9A-9C, a physician system user elects to “edit” the “Operation” file created by the super administrator which comprises three messages to the patient and their contacts regarding pre-op and post-op patient care. The physician modifies the existing message and saves it (see FIG. 9B). He may elect to send a copy of his messages to the super administrator (see FIG. 9C, 910). He may also elect whether to send it to other physicians within the system server (see FIG. 9C, 920 “Share for others”), which comprises transmitting the messages: to specific system users (930); to all system users who perform that type of operation; to all system users with a particular medical specialty (e.g. orthopedics); or to all system users who reside at a particular medical facility.

Similar to FIGS. 9A-9C for diagnosis messages, a physician user can modify the procedure messages for a particular type of surgery that were created by the super administrator, and share them with the super administrator, designated system users; those who perform that type of surgery; those of a specific medical specialty; and/or those residing within a medical facility (see FIGS. 9D-9F).

### Archives

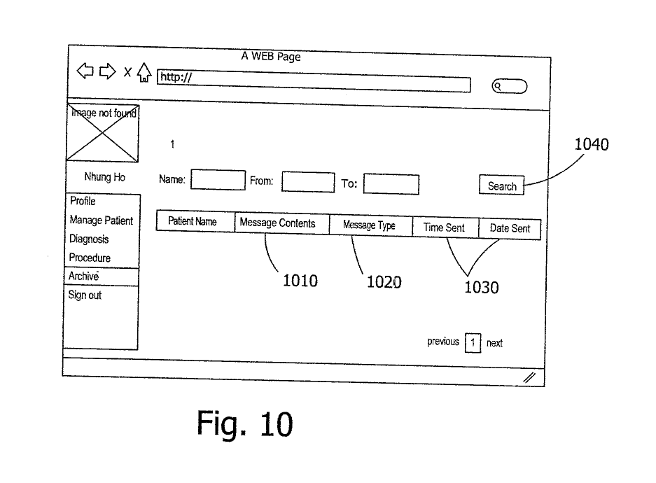

As illustrated in FIG. 10, all messages sent the patient's and their contacts (e.g. diagnosis” and “procedure” messages) are stored in the physician's account on the system server. Each patient's file comprises “Message Content” 1010, which is the text of the message, and “Message Type” 1020 which refers to whether the message is a procedure or diagnosis message and the date and time that each message was sent 1030. The database is also searchable for a patient's record for a specific time period 1040, which is particularly useful if the patient has undergone more than one procedure or has a common name.

Storage of the patient records on the system server of the present invention is in compliance with HIPPA and the HiTech Act, and fulfills the physician's legal obligations for patients' privacy and history of treatment.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

It is to be understood that the phraseology and terminology employed herein is not to be construed as limiting and are for descriptive purpose only. And that the details set forth herein do not construe a limitation to an application of the invention.

Furthermore, it is to be understood that the invention can be carried out or practiced in various ways and that the invention can be implemented in embodiments other than the ones outlined in the description above.

What is claimed is:

1. A computerized method for updating a patient's designated contacts regarding a patient's status for a surgical procedure, comprising:
a) establishing by a physician an account on a computer system server, wherein said account comprises a series of sequential messages regarding phases of a surgical procedure to treat a specific medical disorder;
b) inputting into said account a patient record comprising contact information for electronic messages transmitted from a physician's first electronic computing device to one or more second electronic computing devices of a patient and/or a patient's designated contacts;
c) providing by a physician one of said second electronic computing devices to said patient's designated contacts before said surgical procedure, wherein said second device is pre-configured for direct electronic communication with said physician's first computing device;
d) transmitting said series of sequential messages as each of the phases of said surgical procedure occurs from said first electronic computing device to said second electronic computing device(s) via a secure network; and,
e) archiving said series of sequential messages on said system server within said patient record after said surgical procedure is complete.

2. The method of claim 1, wherein said messages are electronically transmitted from said physician's first electronic computing device within an operating room to said pre-configured patient's contacts second computing device within said hospital.

3. The method of claim 2, wherein said transmission of messages occurs via peer-to-peer communications between said first and said second electronic computing devices over a secure hospital wireless network.

4. The method of claim 3, wherein said peer-to-peer communications comprise video conferencing over said secure hospital wireless network between said physician's first computing device and said patient's contact's second computing device.

5. The method of claim 3, wherein said peer-to-peer communications comprise transmitting a message to a patient's designated contact's social media account.

6. The method of claim 1, wherein said messages are electronically transmitted from said physician's first electronic computing device within an operating room to one or more of said patient's contacts second electronic computing devices located outside of a hospital, and wherein said messages comprises email and/or SMS text messaging.

7. The method of claim 1, wherein said series of sequential messages further comprises diagnosis messages automatically transmitted to a patient and a patient's designated contacts before and after a day of occurrence of said surgical procedure.

8. The method of claim 7, wherein said diagnosis messages comprise instructions for said patient's pre-surgery and post-surgery care outside of said hospital.

9. The method of claim 1, further comprises analyzing by the system processor(s) one or more efficiency metrics for a surgical team, hospital, and/or type of surgical procedure.

10. A computerized system for updating a patient's designated contacts regarding a patient's status for a surgical procedure, comprising:
a) a patient's physician's first electronic computing device transmitting electronic communications to one or more second electronic computing a patient's and a patient's designated contact's second electronic computing device.
b) a secure network for transmitting the electronic communications between said first electronic computing device and said second electronic computing device(s).
c) a system server, comprising;
i. a database storing records of electronic messages transmitted between a physician's first electronic computing device, and one or more of said patient's and/or said patient's contact's second electronic computing devices;
ii. one or more processors;
iii. a non-transitory computer-readable storage media to direct the processors to execute instructions to perform operations comprising;
establishing by a physician an account on the system server comprising a series of sequential messages regarding phases of a surgical procedure to treat a specific medical disorder;
inputting into said account a patient record comprising contact information for electronic messages transmitted from said physician's first electronic computing device to one or more of said patient's and patient's designated contact's second electronic computing device;
providing by a physician one of said second electronic computing devices to said patient's designated contacts before said surgical procedure, wherein said second device is pre-configured for direct electronic communication with said physician's first computing device;
archiving said series of sequential messages on said system server within said patient record after said surgical procedure is complete.

11. The system of claim 10, wherein said messages are electronically transmitted from said physician's first electronic computing device within an operating room to said pre-configured patient's contacts second computing device within said hospital.

12. The system of claim 11, wherein said transmission of messages occurs via peer-to-peer communications between said first and said second electronic computing devices over a secure hospital wireless network.

13. The system of claim 12, wherein said peer-to-peer communications comprise video conferencing over said secure hospital wireless network between said physician's first computing device and said patient's contact's second computing device.

14. The system of claim 13, wherein said peer-to-peer communications comprise transmitting a message to a patient's designated contact's social media account.

15. The system of claim 10, wherein said messages are electronically transmitted from said physician's first electronic computing device within an operating room to one or more of said patient's contacts second electronic computing devices located outside of a hospital, and wherein said messages comprises email and/or SMS text messaging.

16. The system of claim 10, wherein said series of sequential messages further comprises diagnosis messages automatically transmitted to a patient and a patient's designated contacts before and after a day of occurrence of said surgical procedure.

17. The system of claim 16, wherein said diagnosis messages comprise instructions for said patient's pre-surgery and post-surgery care outside of said hospital.

18. The system of claim 10, further comprises analyzing by the system processor(s) one or more efficiency metrics for a surgical team, hospital, and/or type of surgical procedure.

19. A non-transitory computer-readable storage media having stored therein a set of instructions that when executed by a first electronic computing device cause said device:
a) to transmit one each of a series of sequential messages to a second electronic computing device via a secure network;
b) wherein said messages comprise details of each phase of a surgical procedure a patient is currently undergoing;
c) wherein said first computing device is operated by a physician within an operating room and said second computing device is operated by a patient's contact within a hospital, and said secure network is a hospital wireless network; and,
d) wherein said first computing device is operated by a physician within an operating room and said second computing device is operated by a patient's contact outside of a hospital, and said secure network and said first and second device are enabled for SMS text messaging.

20. The non-transitory computer-readable storage media of claim 19, wherein said messages are downloaded from a system server database before said surgical procedure, and a record of said message transmissions and the patient's post-operative status is uploaded to said system database after said surgical procedure.
